(19) United States
(12) Patent Application Publication
(10) Pub. No.: US 2015/0212649 A1
(43) Pub. Date: Jul. 30, 2015

(54) TOUCHPAD INPUT DEVICE AND TOUCHPAD CONTROL PROGRAM

(71) Applicant: ALPS ELECTRIC CO., LTD., Tokyo (JP)

(72) Inventors: Kazuhito Oshita, Miyagi-ken (JP); Hiroshi Shigetaka, Miyagi-ken (JP)

(21) Appl. No.: 14/600,833

(22) Filed: Jan. 20, 2015

(30) Foreign Application Priority Data
Jan. 27, 2014 (JP) 2014-011973

(51) Int. Cl. G06F 3/041; G06F 3/0354

(52) U.S. Cl. CPC G06F 3/0418; G06F 3/03547

(57) ABSTRACT

A control unit, has a palm rejection function to determine whether a contact region of an object, calculated by detecting electric variance due to the object in proximity of an operating face, is from an fingertip or from a palm. The control unit determines that in a case where the difference between an area of the a first proximity region calculated at a first sensitivity and an area of a second proximity region calculated at a second sensitivity higher than the first sensitivity is large, the contact region is from a palm, and at in a case where the difference is small, the contact region is from a fingertip.

### CLAIM OF PRIORITY

This application claims benefit of priority to Japanese Patent Application No. 2014-011973 filed on Jan. 27, 2014, which is hereby incorporated by reference in its entirety.

### BACKGROUND

1. Field of the Disclosure

The present disclosure relates to a touchpad input device installed in a laptop personal computer (PC) or the like, and to a touchpad control program.

2. Description of the Related Art

Touchpads provided to laptop PCs and so forth have tended to become larger in size in recent years. The palm of the hand thus more readily comes into contact with the touchpad input device when operating the keyboard, resulting in erroneous operation. Those provided with a palm rejection function, which invalidates operations in a case of determining a palm, are coming into widespread use as a way of preventing such erroneous operations. Being able to accurately distinguish whether a fingertip or a palm is demanded to improve capabilities of the palm rejection function.

Japanese Unexamined Patent Application Publication 2011-501261 discloses an arrangement where whether a fingertip or a palm is determined based on spatial properties, such as the area and shape of the contact region, and invalidates operations in a case of determining to be a palm. This enables erroneous operations by the palm to be prevented to a certain extent. However, there has been a problem in that whether the touch is by a fingertip or a palm cannot be distinguished if the area and shape of a contact region when touched by a fingertip resembles the area and shape of a contact region when touched by a palm.

### SUMMARY

A touchpad input device includes a control unit, having a palm rejection function to determine whether a contact region of an object, calculated by detecting electric variance due to the object in proximity of an operating face, is from an fingertip or from a palm. The control unit determines whether the contact region is from a fingertip or from a palm based on a proximity region at a position near to the operating face and a proximity region at a position far from the operating face.

According to the touchpad input device of the first aspect, while the fingertip tends to quickly be distanced from the operating screen at the peripheral portion, the palm tends to be gradually distanced from the operating screen at the peripheral portion, so the proximity region at a position far from the operating face becomes small in the case of a fingertip, and the proximity region at a position far from the operating face becomes large in the case of a palm. Accordingly, even if the contact region area and shape appear similar, whether a fingertip or a palm can be distinguished by looking at the proximity region at a position close to the operating face and the proximity region at a position far from the operating face.

According to a second aspect, a touchpad control program stored in a non transitory memory has a palm rejection function to determine whether a contact region of an object, calculated by detecting electric variance due to the object in proximity of an operating face, is from a fingertip or from a palm. The control unit determines that, in a case where the difference between an area of the a first proximity region calculated at a first sensitivity and an area of a second proximity region calculated at a second sensitivity higher than the first sensitivity is large, the contact region is from a palm, and at in a case where the difference is small, the contact region is from a fingertip.

Determination may be made that in a case where the difference between an area of the a first proximity region calculated at a first sensitivity and an area of a second proximity region calculated at a second sensitivity higher than the first sensitivity is large, the contact region is from a palm, and at in a case where the difference is small, the contact region is from a fingertip.

### BRIEF DESCRIPTION OF THE DRAWINGS

FIG. 1 is a diagram illustrating a touchpad installed in a laptop personal computer according to an embodiment;

FIG. 2 is a system configuration diagram of the touchpad input device according to the embodiment;

FIG. 3 is a flowchart for a control unit according to the embodiment; and

FIG. 4 is a diagram for describing the state of proximity regions and so forth when a fingertip and a palm are brought into proximity.

### DESCRIPTION OF THE EXEMPLARY EMBODIMENTS

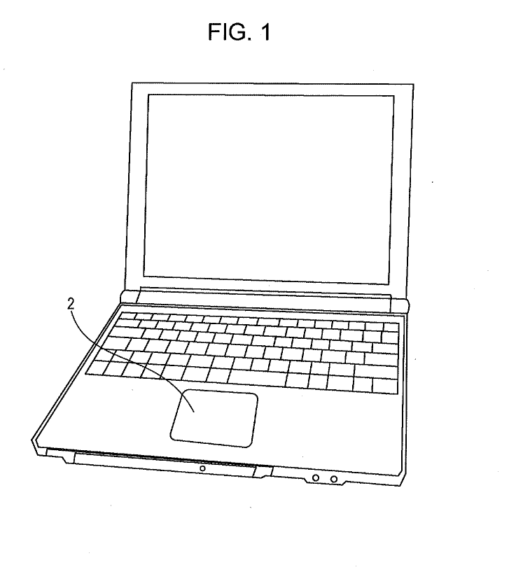

A touchpad input device 1 according to the present embodiment will be described with reference to FIGS. 1 through 4. FIG. 1 is a diagram illustrating a touchpad 2 installed in a laptop personal computer (PC) according to the present embodiment. The touchpad 2 is attached at the middle of a palm rest portion, on the near side of a keyboard.

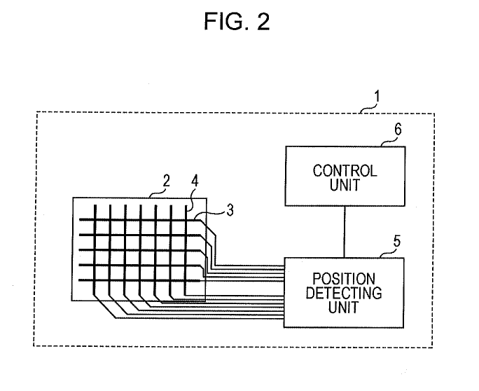

FIG. 2 is a system configuration diagram of the touchpad input device 1. The touchpad input device 1 is configured including the touchpad 2, a position detecting unit 5 made up of an application-specific integrated circuit (ASIC) or the like connected to the touchpad 2 via multiple wires, and a control unit 6 connected to the position detecting unit 5. The touchpad 2 is configured including the printed circuit board, multiple detecting electrodes 3 laid on the printed circuit board extending in the horizontal direction, multiple driving electrodes 4 laid extending in the vertical direction, above the detecting electrodes 3, with an insulating layer interposed therebetween, and a surface sheet applied on the upper side of the driving electrodes 4. The upper face of the surface sheet serves as the operating face. Based on the voltage application state to the driving electrodes 4 and the voltage detection state of the detecting electrodes 3, the position detecting unit 5 detects change in capacitance between the electrodes, detects the contact position of an object such as a fingertip or the like, generates position signals thereof and thereby detects a contact position of a finger or the like, and transmits the position signals to the control unit 6. The control unit 6 receives position signals from the position detecting unit 5 to recognize touch operations being made on the operating face. The control unit 6 stores control programs in a non transitory memory according to the present embodiment, and executes control operations according to the present embodiment. Note that the position detecting unit 5 and control unit 6 are illustrated as being separate components, but these may be integral.

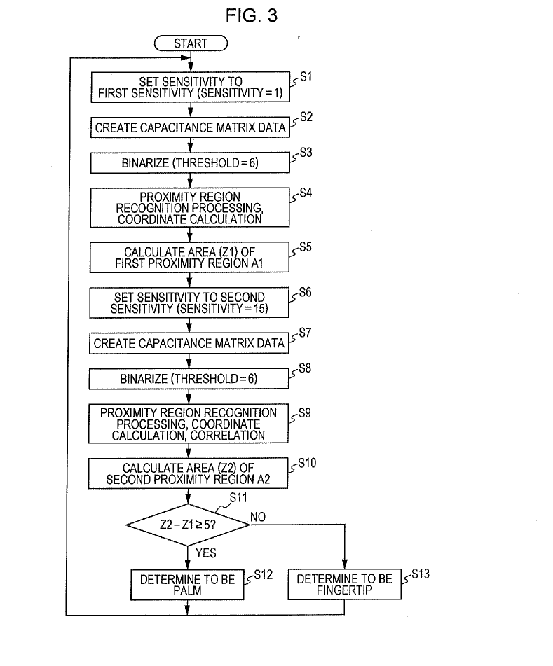

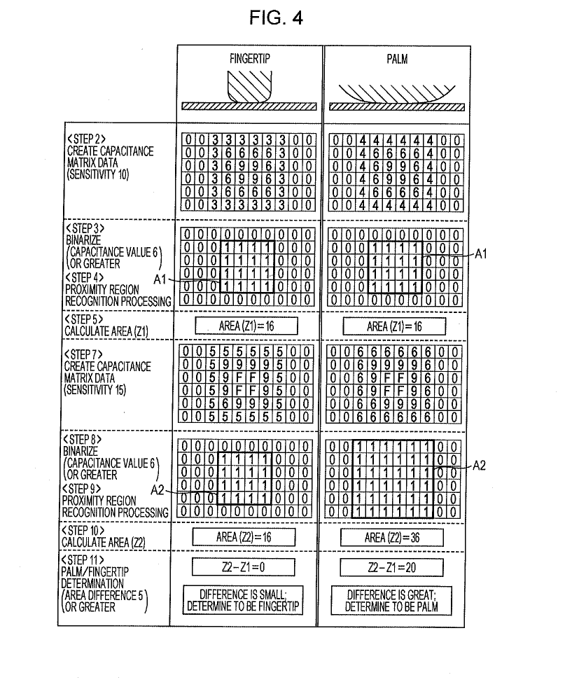

FIG. 3 is a flowchart illustrating the control operations of the control unit 6 according to the present embodiment. FIG. 4 is a diagram for describing the state of proximity regions and so forth when a fingertip and a palm are brought into proximity. The operations of the touchpad input device 1 according to the present embodiment will be described with reference to FIGS. 3 and 4.

First, in step S1, sensitivity is set to a first sensitivity (sensitivity=10). The sensitivity at this time is normal sensitivity.

In step S2, capacitance matrix data is compiled.

In step S3, binarization is performed. Capacitance values of 5 or smaller are set to 0, and capacitance values of 6 or larger are set to 1.

In step S4, proximity region recognition processing is performed, a first proximity region A1 is identified as illustrated in FIG. 4, and coordinates calculation is performed. Proximity region recognition processing is processing where a place in which one of the two binarization values forms a group is recognized as a fingertip. Coordinates calculation processing where, with regard to the one group, coordinates of the center of gravity are calculated, for example.

In step S5, the area (Z1) of the first proximity region A1 is calculated.

In step S6, sensitivity is set to a second sensitivity (sensitivity=15). The sensitivity at this time is higher than normal sensitivity.

In step S7, capacitance matrix data is compiled.

In step S8, binarization is performed. Capacitance values of 5 or smaller are set to 0, and capacitance values of 6 or larger are set to 1.

In step S9, proximity region recognition processing is performed, a second proximity region A2 is identified as illustrated in FIG. 4, coordinates calculation is performed, and correlation with the first proximity region A1 is performed.

In step S10, the area (Z2) of the second proximity region A2 is calculated.

In step S11, a difference (Z2−Z1) between the area of the second proximity region A2 (Z2) and the area of the first proximity region A1 (Z1) may be calculated, and determination made regarding whether or not the value is 5 or greater. In a case where the value is determined to be 5 or greater, the flow may advance to step S12 and determination be made that the first proximity region A1 is a palm, and in a case where the value is determined not to be 5 or greater, the flow may advance to step S13 and determination be made that the first proximity region A1 is a fingertip, and the flow returns to step S1.

Thus, the present embodiment includes the control unit 6 having a palm rejection function to determine whether the contact region (first proximity region A1) of the object calculated from detected change in electrical variance of an object coming into proximity with the operating face is from a fingertip or from a palm. The control unit 6 may determine whether the contact region (first proximity region A1) is from a fingertip or from a palm, based on the difference (Z2−Z1) between the area Z1 of the first proximity region A1 at a close position from the operating face and the area Z2 of the second proximity region A2 including a proximity region at a position far from the operating face.

Accordingly, while the fingertip tends to quickly be distanced from the operating screen at the peripheral portion, the palm tends to be gradually distanced from the operating screen at the peripheral portion, so the difference between the area Z1 of the first proximity region A1 and the area Z2 of the second proximity region A2 (Z2−Z1) becomes small in the case of a fingertip, and the difference between the area Z1 of the first proximity region A1 and the area Z2 of the second proximity region A2 (Z2−Z1) is large in the case of a palm. Accordingly, even if the contact region area and shape appear similar, whether the touch is by a fingertip or a palm can be distinguished by looking at the difference between the area Z1 of the first proximity region A1 and the area Z2 of the second proximity region A2 (Z2−Z1).

Also, the control unit 6 according to the present embodiment may make determination that in a case where the difference between the area Z1 of the first proximity region Al calculated at the first sensitivity and the area Z2 of the second proximity region A2 calculated at the second sensitivity higher than the first sensitivity (Z2−Z1) is large, the contact region is from a palm, and at in a case where the difference (Z2−Z1) is small, the contact region is from a fingertip.

Accordingly, the area of the first proximity region A1 and the area of the second proximity region A2 can be easily obtained.

Note that the present invention is not restricted to the above-described embodiment, and that various modifications may be made without departing from the essence of the present invention. While the present embodiment has been described as calculating two proximity regions with different sensitivities, the present invention is not restricted to this, and two proximity regions may be calculated with different threshold values rather than different sensitivities. Also, while present embodiment has been described as calculating the difference in areas (Z2−Z1), the present invention is not restricted to this, and determination may be made based on the ratio of the areas (Z2/Z1).

What is claimed is:

1. A touchpad input device comprising:
a control unit, having a palm rejection function to determine whether a contact region of an object, calculated by detecting electric variance due to the object in proximity of an operating face, is from a fingertip or from a palm;
wherein the control unit determines whether the contact region is from a fingertip or from a palm based on a proximity region at a position near to the operating face and a proximity region at a position far from the operating face.

2. The touchpad input device according to claim 1, wherein the control unit determines that in a case where the difference between an area of the a first proximity region calculated at a first sensitivity and an area of a second proximity region calculated at a second sensitivity higher than the first sensitivity is large, the contact region is from a palm, and at in a case where the difference is small, the contact region is from a fingertip.

3. A non transitory memory having stored therein a touchpad control program, the control program having a palm rejection function to determine whether a contact region of an object, calculated by detecting electric variance due to the object in proximity of an operating face, is from a fingertip or from a palm;
wherein whether the contact region is from a fingertip or from a palm is determined based on a proximity region at a position near to the operating face and a proximity region at a position far from the operating face.

4. The touchpad control program according to claim 3, wherein determination is made that in a case where the difference between an area of the a first proximity region calculated at a first sensitivity and an area of a second proximity region calculated at a second sensitivity higher than the first sensitivity is large, the contact region is from a palm, and at in a case where the difference is small, the contact region is from a fingertip.
